(19) United States
(12) Patent Application Publication
(10) Pub. No.: US 2026/0145430 A1
(43) Pub. Date: May 28, 2026

(54) LIQUID DISCHARGE HEAD, HEAD UNIT, AND LIQUID DISCHARGE APPARATUS

(71) Applicants: Yuki FUJIMURA, Kanagawa (JP); Kiyoaki FUKUYAMA, Kanagawa (JP); Yuya OHSHIMA, Kanagawa (JP)

(72) Inventors: Yuki FUJIMURA, Kanagawa (JP); Kiyoaki FUKUYAMA, Kanagawa (JP); Yuya OHSHIMA, Kanagawa (JP)

(21) Appl. No.: 19/357,106

(22) Filed: Oct. 14, 2025

(30) Foreign Application Priority Data
Nov. 22, 2024 (JP) 2024-203915

(51) Int. Cl. B41J 2/14; B41J 2/16; B41J 2/165

(52) U.S. Cl. CPC B41J 2/14274; B41J 2/1612; B41J 2/1623; B41J 2/16505

(57) ABSTRACT

A liquid discharge head includes: a nozzle plate having a nozzle to discharge a liquid in a discharge direction; a damper; a damper support having: a first face facing in the discharge direction, the first face supporting the damper; a second face facing in an opposite direction opposite to the discharge direction; a through hole opened to the opposite direction; and a joining portion on the second face and facing in the opposite direction; and a joint joined to the joining portion of the damper support with an adhesive. The damper support includes a step rising to the opposite direction from the joining portion, and the step is disposed between the joining portion and the through hole in a transverse direction orthogonal to the discharge direction.

### CROSS-REFERENCE TO RELATED APPLICATION

This patent application is based on and claims priority pursuant to 35 U.S.C. § 119(a) to Japanese Patent Application No. 2024-203915, filed on Nov. 22, 2024, in the Japan Patent Office, the entire disclosure of which is hereby incorporated by reference herein.

### BACKGROUND

### Technical Field

The present embodiment relates to a liquid discharge head, a head unit, and a liquid discharge apparatus.

### Related Art

A liquid discharge head that deforms a piezoelectric body to discharge ink as liquid is provided with a damper for absorbing vibration propagated to an adjacent liquid chamber due to the deformation of the piezoelectric body or vibration due to fluctuations in ink flow rate.

A damper frame (damper support) that holds a damper is stacked on the damper, and a cover pedestal (joint) is joined to the damper frame with an adhesive. The cover pedestal is a pedestal portion of a cover that covers an upper portion of the liquid discharge head.

An object of the present embodiment is to suppress entry of an adhesive into a through hole.

### SUMMARY

The present disclosure described herein provides a liquid discharge head including: a nozzle plate having a nozzle to discharge a liquid in a discharge direction; a damper; a damper support having: a first face facing in the discharge direction, the first face supporting the damper; a second face facing in an opposite direction opposite to the discharge direction; a through hole opened to the opposite direction; and a joining portion on the second face and facing in the opposite direction; and a joint joined to the joining portion of the damper support with an adhesive. The damper support includes a step rising to the opposite direction from the joining portion, and the step is disposed between the joining portion and the through hole in a transverse direction orthogonal to the discharge direction.

The present disclosure described herein further provides a liquid discharge head including: a nozzle plate having a nozzle to discharge a liquid in the discharge direction; a damper; a damper support having: a first face facing in the discharge direction, the first face supporting the damper; a second face facing in an opposite direction opposite to the discharge direction; a through hole opened to the opposite direction; and a joining portion on the second face and facing in the opposite direction; and a joint joined to the joining portion of the damper support with an adhesive. The damper support includes a protrusion protruding to the opposite direction from the joining portion, and the protrusion is disposed between the joining portion and the through hole in a transverse direction orthogonal to the discharge direction.

### BRIEF DESCRIPTIONS OF DRAWINGS

A more complete appreciation of embodiments of the present disclosure and many of the attendant advantages and features thereof can be readily obtained and understood from the following detailed description with reference to the accompanying drawings, wherein:

FIG. 1 is a front view of a head unit including a liquid discharge head according to the present embodiment;

FIG. 2 is a perspective view of the liquid discharge head and a cover according to the present embodiment;

FIG. 3 is a cross-sectional view of A of FIG. 2;

FIG. 4 is a cross-sectional view of the liquid discharge head as viewed from above;

FIG. 5 is a cross-sectional view taken along line B1-B1 of FIG. 4;

FIG. 6 is a perspective view illustrating a portion where a cover pedestal is joined to a second damper frame in a liquid discharge head different from the liquid discharge head of the above embodiment;

FIG. 7 is a cross-sectional view of D1 of FIG. 6;

FIG. 8 is a perspective view illustrating a portion where a cover pedestal is joined to a second damper frame in the liquid discharge head of FIG. 2;

FIG. 9 is a cross-sectional view of D2 of FIG. 8;

FIG. 10 is a plan view illustrating a longitudinal recessed portion provided in the second damper frame;

FIG. 11 is a cross-sectional view illustrating a wall portion formed by burring;

FIG. 12 is a cross-sectional view illustrating a wall portion made of a burr;

FIG. 13 is a cross-sectional view illustrating another example of a step;

FIG. 14 is a cross-sectional view taken along line B2-B2 of FIG. 4;

FIG. 15 is a cross-sectional view illustrating an abutment portion provided in the second damper frame;

FIG. 16 is a schematic configuration view of a printing apparatus including the liquid discharge head of the present embodiment;

FIG. 17 is a plan view of the liquid discharge head provided in the printing apparatus of FIG. 16 as viewed from a nozzle face side;

FIG. 18 is a plan view illustrating a main part of a printing apparatus of another example;

FIG. 19 is a side view illustrating a main part of the printing apparatus of FIG. 18;

FIG. 20 is a plan view illustrating a main part of a liquid discharge unit of another example; and

FIG. 21 is a front view illustrating a main part of a liquid discharge unit according to yet another example.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, the present embodiment will be described with reference to the drawings. Identical parts are given identical reference numerals and redundant descriptions are summarized or omitted accordingly.

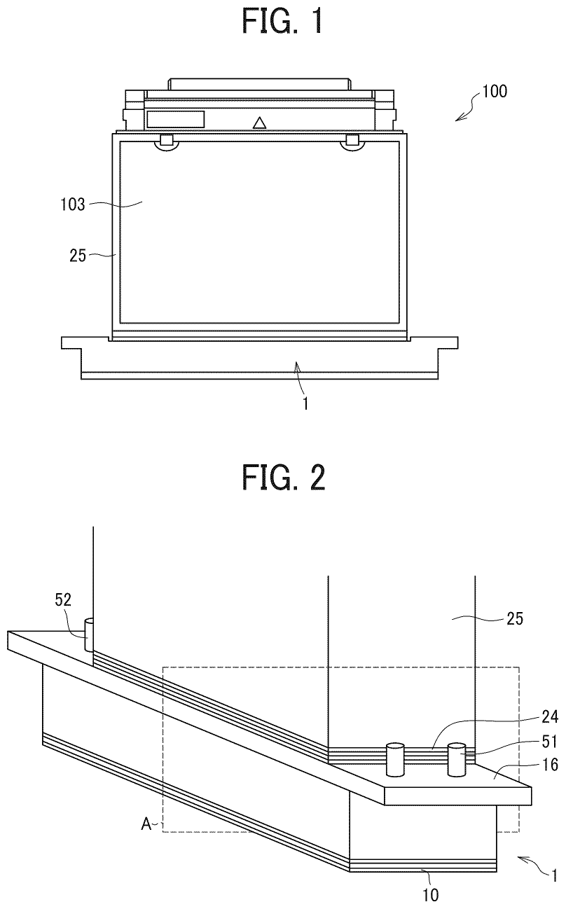

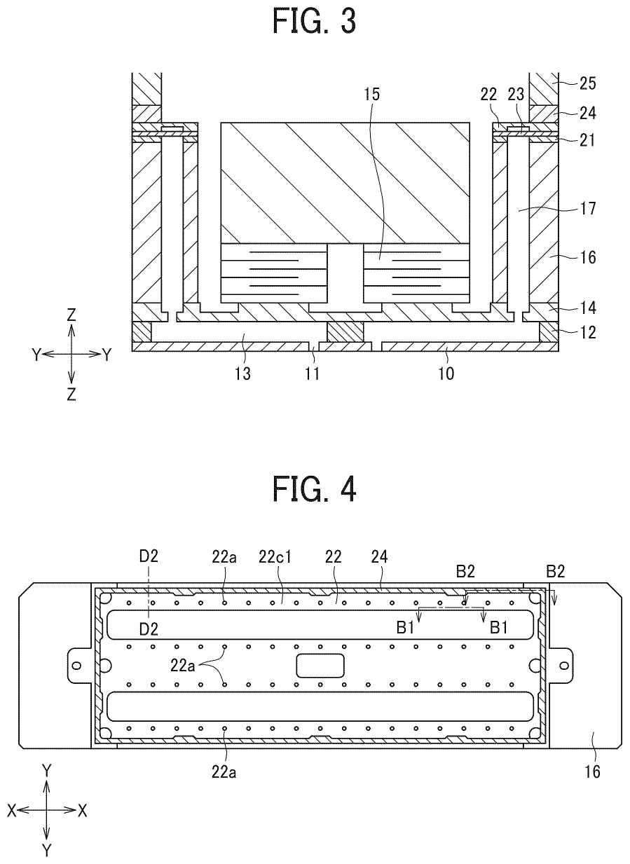

FIG. 1 is a front view of a head unit including a liquid discharge head according to an embodiment of the present embodiment. FIG. 2 is a perspective view of the liquid discharge head and a cover according to an embodiment of the present embodiment, and FIG. 3 is a cross-sectional view of A of FIG. 2.

A head unit 100 includes a liquid discharge head 1, a cover 25, a heat sink 103 as a heat dissipation member, and the like. The heat sink 103 can be formed of a metal member or a resin such as a highly thermally conductive polycarbonate resin.

A cover 25 covers a side of the liquid discharge head 1 opposite to a nozzle side, and an electric portion is provided inside the cover. As illustrated in FIG. 2, the cover 25 is joined to an upper portion of a cover pedestal 24 provided in the liquid discharge head 1. The cover pedestal 24 is joined to an upper portion of a common channel member 16. The cover pedestal 24 is formed of, for example, a resin material. The common channel member 16 includes a supply port 51 that supplies ink as liquid to the liquid discharge head 1 and a collection port 52 that collects the ink from the liquid discharge head 1. The cover pedestal 24 may referred to also as a “joint”.

As illustrated in FIG. 3, the liquid discharge head 1 includes a nozzle plate 10 as a nozzle member, a channel substrate 12, a diaphragm 14, a piezoelectric element 15, the common channel member 16, a first damper frame 21, a second damper frame 22 as a damper support, a damper 23, the cover pedestal 24, and the like, and these members are stacked in an up-down direction of FIG. 3. An up-down direction Z in FIG. 3 is referred to as an up-down direction for convenience, but this does not necessarily indicate the gravity direction or its opposite direction. The up-down direction Z is also a stacking direction of the members such as the common channel member 16, and is also a direction parallel to a joining direction of the cover pedestal 24 to the second damper frame 22 and a liquid discharge direction from the nozzle. The upward direction in FIG. 3 is a direction toward the cover pedestal 24 as viewed from the second damper frame 22.

The damper 23 is a member having flexibility. The damper 23 is sandwiched between the first damper frame 21 and the second damper frame 22. The first damper frame 21 holds the damper 23 from the nozzle plate 10 side including a nozzle 11. The second damper frame 22 holds the damper 23 from a side opposite to the nozzle plate 10 side including the nozzle 11.

The nozzle plate 10 is provided with multiple nozzles 11. An individual liquid chamber 13 is formed inside the channel substrate 12. The common channel member 16 forms a common channel 17 inside the common channel member 16. The common channel 17 leads to each individual liquid chamber 13. The stack-type piezoelectric element 15 is a pressure force generation device that deforms the diaphragm 14 to pressurize the ink in the individual liquid chamber 13. The cover 25 covers and protects the common channel member 16, the piezoelectric element 15, and the like from above.

The channel shapes of the channel substrate 12, the first damper frame 21, and the second damper frame 22 can be formed by, for example, etching a substrate made of SUS using an acidic etching solution or machining such as punching.

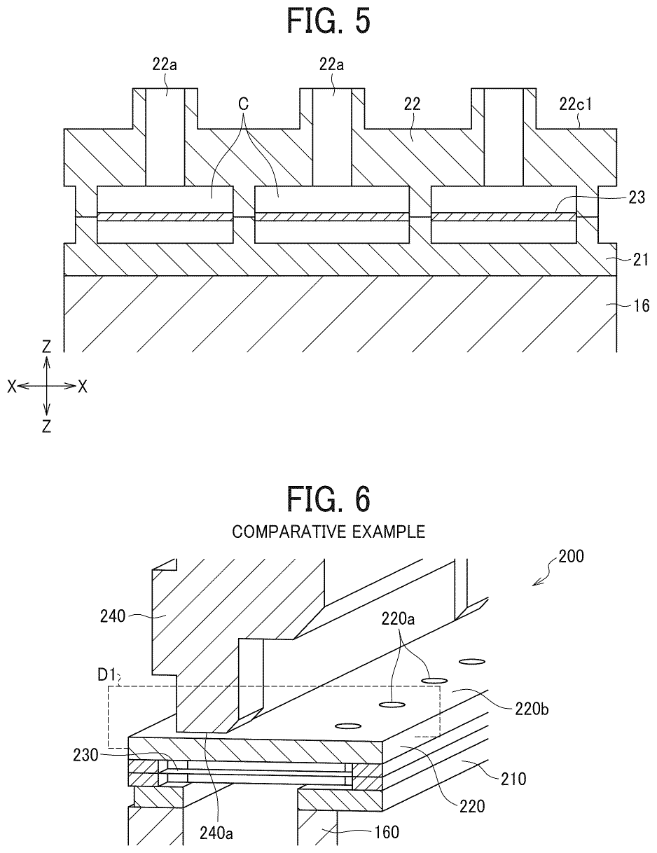

FIG. 4 is a cross-sectional view of the liquid discharge head 1 as viewed from above, and FIG. 5 is a cross-sectional view taken along line B1-B1 of FIG. 4. A direction X, which is a left-right direction in FIG. 4, is a longitudinal direction of the second damper frame 22, the cover pedestal 24, and the like, and hereinafter, this direction is also simply referred to as a longitudinal direction. A direction Y, which is an up-down direction in FIG. 4, is a lateral direction of the second damper frame 22, the cover pedestal 24, and the like, and hereinafter, this direction is also simply referred to as a lateral direction.

As illustrated in FIG. 4, the cover pedestal 24 is joined to an upper face of the second damper frame 22 so as to surround the periphery of the second damper frame 22. The second damper frame 22 is provided with multiple through holes 22a. In the second damper frame 22, the multiple through holes 22a arranged in a row in the longitudinal direction is formed in multiple rows in the lateral direction. As illustrated in FIG. 5, one side of the through hole 22a communicates with a damper chamber C, and the other side opens above the second damper frame 22, that is, to the cover pedestal side.

The damper chamber C is a region where the damper 23 vibrates. The first damper frame 21 and the second damper frame 22 are stacked to sandwich the damper 23 therebetween, and form the damper chamber C between the first damper frame 21 and the second damper frame 22. Multiple damper chambers C is provided in parallel in the longitudinal direction, and the through holes 22a communicate with the respective damper chambers C.

The vibration of the damper 23 can attenuate a pressure wave and an inertial flow propagating to the common channel member 16 side due to deformation of the piezoelectric element 15, or the like. Since the damper chamber C communicates with the external space via the through hole 22a, the air in the damper chamber C can be released to the outside.

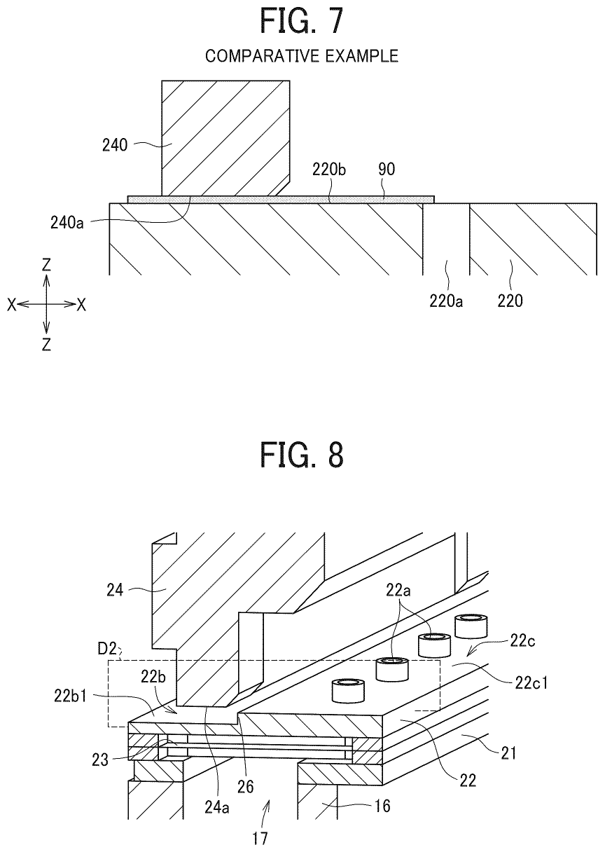

Next, a disadvantage that occurs when the cover pedestal is joined to the second damper frame will be described with reference to FIGS. 6 and 7. FIGS. 6 and 7 illustrate a liquid discharge head 200 including a cover pedestal 240 different from the cover pedestal 24 of the embodiment described above, FIG. 6 is a perspective view illustrating a portion where the cover pedestal 240 is joined to a second damper frame 220, and FIG. 7 is a cross-sectional view of D1 of FIG. 6.

As illustrated in FIGS. 6 and 7, a lower face 240a of the cover pedestal 240 is joined to an upper face 220b of the second damper frame 220 with an adhesive 90. The upper face 220b has substantially the same height in the lateral direction, and ends of through holes 220a are opened to the upper face 220b.

As illustrated in FIG. 7, when the upper face 220b of the second damper frame 220 and the lower face 240a of the cover pedestal 240 are joined, there is a disadvantage that the adhesive 90 overflows from between the two faces and flows into the through holes 220a. As a result, the adhesive 90 blocks the through holes 220a, or the adhesive 90 flows into damper chambers.

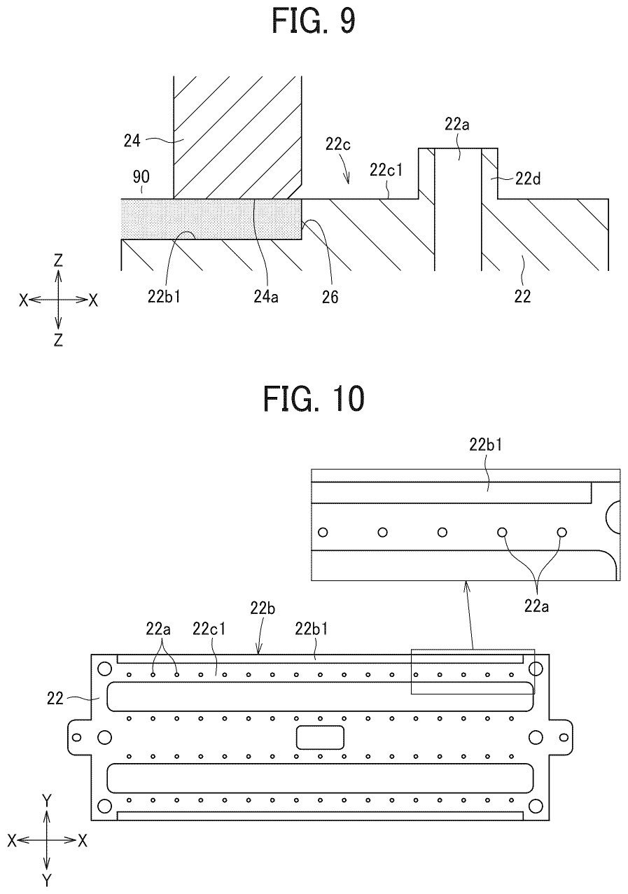

Next, a configuration for suppressing inflow of the adhesive into the through holes of the liquid discharge head 1 of the present embodiment will be described with reference to FIGS. 8 and 9. FIG. 8 is a perspective view illustrating a portion where the cover pedestal 24 is joined to the second damper frame 22, and FIG. 9 is a cross-sectional view of D2 of FIG. 8. FIG. 9 is also a view corresponding to a cross-section taken along line D2-D2 of FIG. 4.

As illustrated in FIGS. 8 and 9, in the present embodiment, a longitudinal recessed portion 22b including a joining face 22b1 of the second damper frame 22 to which the cover pedestal 24 is joined is recessed downward, which in a direction away from the cover pedestal 24. In other words, an upper face 22c including an upper face 22c1 in which ends of the through holes 22a are formed protrudes or rises upward, which is on the cover pedestal 24 side with respect to the longitudinal recessed portion 22b. The longitudinal recessed portion 22b as a joining face portion refers to a lower portion of the step 26 recessed to the side opposite to the cover pedestal 24 side with respect to the upper face 22c1. The upper face 22c as a first face portion refers to an upper portion of the step 26 protruding or rising to the cover pedestal 24 side with respect to the joining face 22b1. A part of the joining face 22b1, that is, a right side portion of the joining face 22b1 in FIG. 9 is a joining portion to be joined to the cover pedestal 24. The joining portion of the second damper frame 22 (damper support) of the present embodiment is a portion that faces a joining part of the cover pedestal 24 (joint) in a joining direction of the cover pedestal 24 with respect to the second damper frame 22 (up-down direction in FIG. 9) and is bonded to the cover pedestal 24 via the adhesive 90.

The step 26 may be a protrusion protruding upward from the joining face 22b1 in FIG. 9.

The cover pedestal 24 is joined so as to surround an outer peripheral face side of the second damper frame 22 (see FIG. 4), and the longitudinal recessed portion 22b of the present embodiment is provided on both end sides (upper side and lower side in FIG. 10) of the second damper frame 22 in the lateral direction as illustrated in FIG. 10. The longitudinal recessed portion 22b extends in the longitudinal direction, and is provided in the region where the through holes 22a in the longitudinal direction are disposed, particularly in the present embodiment, in the entire region where the through holes 22a in the longitudinal direction are disposed.

Since the longitudinal recessed portion 22b is provided in a recessed shape, the upper face 22c can be formed as a step 26 of the present embodiment protruding or rising to the cover pedestal 24 side with respect to the joining face 22b1. With this step 26, as illustrated in FIG. 9, the adhesive 90 for joining the joining face 22b1 and a lower face 24 a of the cover pedestal 24 can be applied to a position one step lower than the upper face 22c1 of the second damper frame 22, and the adhesive 90 can be suppressed from flowing to the upper face 22c1 and the through holes 22a. The step 26 protruding or rising to the cover pedestal 24 side (joint side) does not strictly mean that the step 26 extends in the direction of the cover pedestal 24 (joint side), but means that the step 26 protrudes or rises upward in FIG. 9, which is a direction parallel to the stacking direction of the cover pedestal 24 with respect to the second damper frame 22, with respect to the face of the second damper frame 22 on the cover pedestal 24 side.

In particular, in the present embodiment, the longitudinal recessed portion 22b is provided over the entire region where the through holes 22a in the longitudinal direction are disposed. In other words, over the entire region where the through holes 22a in the longitudinal direction are disposed, the upper face 22c is provided so as to protrude or rises to the cover pedestal 24 side with respect to the joining face 22b1. As a result, it is possible to obtain an effect of suppressing inflow of the adhesive 90 into the through holes 22a with respect to all the through holes 22a. It is also possible to suppress the adhesive 90 from flowing into the through holes 22a from through holes 22a side adjacent in the longitudinal direction.

In the present embodiment, a wall portion 22d having the through hole 22a on the inner side thereof protrudes to the cover pedestal 24 side with respect to the peripheral portion (in particular, in the present embodiment, with respect to the entire upper face 22c, which is the face of the second damper frame 22 on the cover pedestal 24 side). That is, the wall portion 22d forms a step 26 or protrusion 22f protruding to the cover pedestal 24 side with respect to the joining face 22b1. The wall portion 22d has a tubular shape having the through hole 22a on the inner side thereof, but the wall portion 22d may be provided in a part in the circumferential direction.

Since the wall portion 22 d protrudes upward in FIG. 9, even when the adhesive 90 flows onto the upper face 22 c, it is possible to restrict the adhesive 90 from flowing into the through holes 22a.

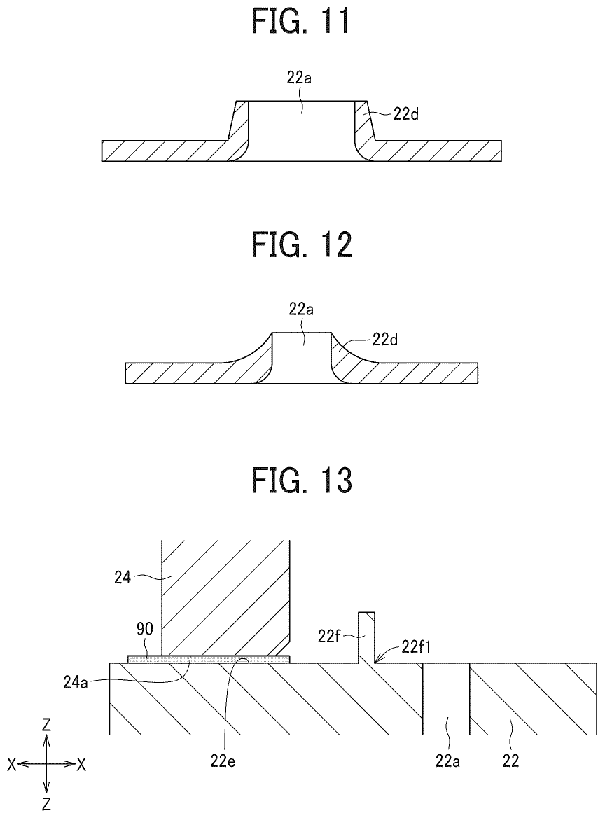

The wall portion 22d protruding upward in FIG. 9 can be formed by burring, for example, as in a wall portion 22d in FIG. 11. As illustrated in FIG. 12, a wall portion 22d protruding upward in FIG. 12 can also be formed by leaving the burr formed when the through hole 22a is formed as it is. A wall portion 22d having a large protrusion amount can be formed by the burring. By forming the wall portion 22d of the burr, the wall portion 22d can be formed without increasing the formation cost of the second damper frame 22.

In the second damper frame 22 of the present embodiment, the upper face 22c protrudes to the cover pedestal 24 side with respect to the joining face 22b1 to form the protrusion. The wall portion 22d protrudes to the cover pedestal 24 side with respect to the joining face 22b1 to form the protrusion. As described above, the second damper frame 22 may be configured to have multiple protrusion, or one of the protrusions (wall portion 22d) described above may be provided. However, by providing both the step 26 and the protrusion protrusions (wall portion 22d) as in the present embodiment, the adhesive 90 does not reach the through holes 22a without passing over the step 26 between the longitudinal recessed portion 22b and the upper face 22c and passing over the wall portion 22d (protrusion), so that the adhesive 90 flowing into the through holes 22a can be more effectively restricted.

A second damper frame 22 including a protrusion 22f different from the step 26 described above is described below with reference to FIG. 13. The protrusion 22f may be a rib protruding from the upper face 22e in the opposite direction (upper direction in FIG. 13).

The second damper frame 22 illustrated in FIG. 13 does not include the longitudinal recessed portion 22b (see FIG. 9) as in the above-described embodiment, and the height of the side of the second damper frame 22 to which the cover pedestal 24 is joined is the same as the height of the side where the end of the through hole 22a is formed. That is, an upper face 22e is a face having the end of the through hole 22a, and is also a face having a joining portion with the cover pedestal 24. The joining portion of the present embodiment is a portion of the upper face 22e facing the cover pedestal 24 in the up-down direction of FIG. 13 via the adhesive 90. A portion where the through hole 22 a is formed does not protrude to the cover pedestal 24 side.

In the present embodiment, instead of the step 26 formed in the embodiment of FIG. 9, a protrusion 22f protruding upward in FIG. 13, which is the cover pedestal 24 side, is provided between the joining portion of the upper face 22e and the through hole 22a. The rib is an example of a protrusion.

The protrusion 22f extends over the entire range in which the through holes 22a in the longitudinal direction (the direction perpendicular to the sheet of FIG. 13) are provided. However, multiple protrusions 22f may be provided to face the through holes 22a, and the arrangement of the protrusion 22f can be appropriately changed.

By providing the protrusion 22f, even when the adhesive 90 leaks from between the upper face 22e of the second damper frame 22 and the lower face 24a of the cover pedestal 24, it is possible to suppress the adhesive 90 from flowing into the through holes 22a. In addition to the protrusion 22f of FIG. 13, the configuration of each step illustrated in FIG. 9 may be provided.

Next, advantages of each step described above will be described.

As illustrated in FIG. 9, when the upper face 22c side is formed into a step, the step can be formed by forming the longitudinal recessed portion 22b by, for example, cutting one end side of the second damper frame 22. For example, in a case where the protrusion 22f is formed by cutting in FIG. 13, it is necessary to cut both sides of the protrusion 22f, and the machining cost can be reduced in a case where the longitudinal recessed portion 22b is formed. When the step is formed by the wall portion 22d, the step can be formed at a lower cost by forming the step by the above-described burring or using the burr as the step.

In the configuration in which the longitudinal recessed portion 22b is formed, the step can be formed on the side farther from the through hole 22a, and the inflow of the adhesive can be suppressed on the side far from the through hole 22a. Therefore, in particular, as compared with a case where the protrusion 22f is provided near the through hole 22a or a case where the step is formed by the wall portion 22d, even when the adhesive flows out to the through hole 22a side over the step shape between the longitudinal recessed portion 22b and the upper face 22c, there is an advantage that the adhesive 90 is less likely to flow into the through hole 22a. However, by providing the protrusion 22f on the side far from the through hole 22a, the inflow of the adhesive 90 into the through hole 22a can be further suppressed. In the case of the configuration of the protrusion 22f, the adhesive 90 can be adhered/deposited on the protrusion 22f, and in particular, the adhesive 90 easily stays due to face tension at the position of a corner portion 22f1 between the protrusion 22f and the upper face 22e illustrated in FIG. 13. There is an advantage that the inflow of the adhesive 90 into the through hole 22a can be further suppressed. In the case of the configuration in which the step is formed by the wall portion 22d, the machining range can be limited to the periphery of the through hole 22a, and the inflow of the adhesive 90 into the through hole 22a from any direction can be suppressed.

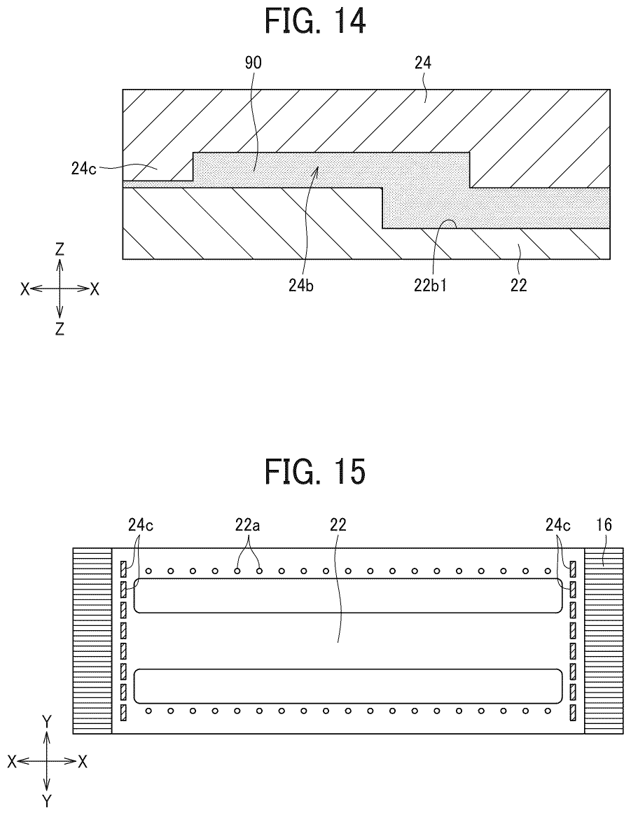

FIG. 14 is a cross-sectional view taken along line B2-B2 of FIG. 4.

As illustrated in FIG. 14, in the present embodiment, a pedestal-side recessed portion 24b as a joint-side recessed portion that is recessed with respect to the second damper frame 22 is provided on the lower face side at both ends of the cover pedestal 24 in the longitudinal direction. The pedestal-side recessed portion 24b is provided across the lateral direction of the cover pedestal 24 (the direction perpendicular to the sheet of FIG. 14). The pedestal-side recessed portion 24b partially faces the longitudinal recessed portion 22b of the second damper frame 22 in the longitudinal direction. That is, the pedestal-side recessed portion 24b partially overlaps the position in the longitudinal direction where the upper face 22c (see FIG. 8) of the second damper frame 22 protrudes or rises to the cover pedestal 24 side with respect to the longitudinal recessed portion 22b to form the step 26 of the present embodiment.

By providing the pedestal-side recessed portion 24b and increasing the gap between the cover pedestal 24 and the second damper frame 22 at both ends in the longitudinal direction, it is possible to reduce the pressure force applied to the adhesive 90 when the cover pedestal 24 and the second damper frame 22 are joined, and to suppress the adhesive 90 from being squeezed by the cover pedestal 24 and the second damper frame 22 and overflowing from therebetween. It is possible to suppress inflow of the adhesive 90 into the through hole 22a.

The cover pedestal 24 includes an abutment portion 24c abutted against the second damper frame 22. The abutment portion 24c is a portion provided on the second damper frame 22 side of the cover pedestal 24, that is, on the lower side, and protruding to the second damper frame 22 side with respect to the other portion of the cover pedestal 24. Since the abutment portion 24c abuts against the second damper frame 22, a gap between the joining face 22b1 and the lower face 24a illustrated in FIG. 9 can be maintained until the adhesive 90 is applied and cured between the second damper frame 22 and the cover pedestal 24. As a result, the joining face 22b1 and the lower face 24a can be joined in a state where a thick layer of the adhesive 90 as illustrated in FIG. 14 is formed therebetween.

The abutment portion 24c is provided in a region other than the region where the through holes 22a of the second damper frame 22 are provided. That is, as illustrated in FIG. 15, the abutment portion 24c is provided at a position not overlapping the through holes 22a on an X-Y plane perpendicular to the stacking direction of the second damper frame 22 and the cover pedestal 24. In particular, in the present embodiment, the abutment portion 24c is provided at positions at both ends of the second damper frame 22 in the longitudinal direction in a region outside the region where the through holes 22a in the longitudinal direction are provided. At both ends in the longitudinal direction, multiple abutment portions 24c is arranged in a row in the lateral direction. However, the abutment portions 24c may be provided longitudinally in the lateral direction.

In this manner, by providing the abutment portion 24c at a position away from the position where the through hole 22a is provided, for example, at positions at both ends in the longitudinal direction, even when the adhesive applied between the abutment portion 24c and the second damper frame 22 leaks out, it is possible to prevent the adhesive from reaching the through hole 22a.

In the above description, the case where the cover pedestal 24 is provided with the abutment portions 24c protruding to the second damper frame 22 side has been exemplified. The second damper frame 22 may be provided with an abutment portion that protrudes to the cover pedestal 24 side and abuts against the cover pedestal 24, or both the cover pedestal 24 and the second damper frame 22 may be provided with abutment portions that protrude toward and contact the other side.

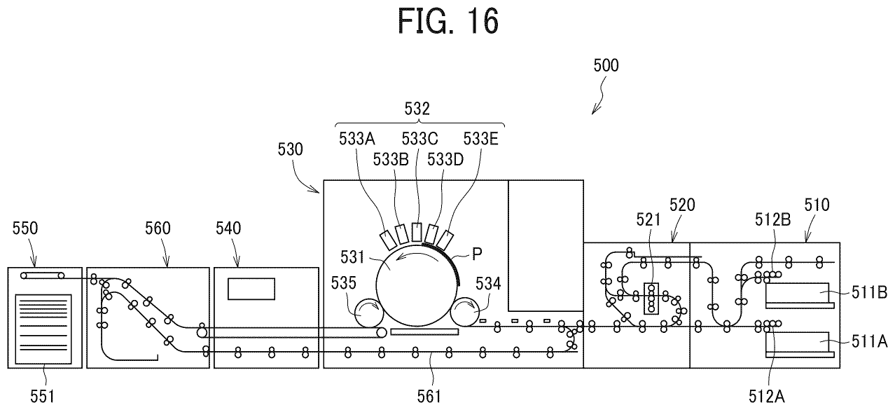

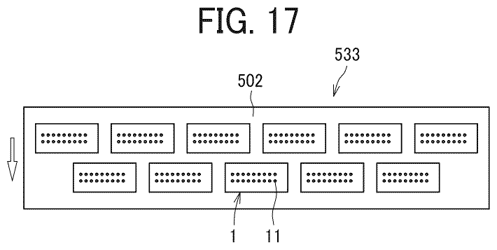

Next, an example of a printing apparatus including the liquid discharge head of the present embodiment will be described with reference to FIGS. 16 and 17. FIG. 16 is a schematic explanatory view of a printing apparatus as the liquid discharge apparatus according to the embodiment, and FIG. 17 is a plan explanatory view of a discharge unit of the printing apparatus as viewed from a nozzle face side.

A printing apparatus 500 includes a loading portion 510 to load a sheet material P, a pretreatment portion 520, a printing portion 530, a drying portion 540, and an unloading portion 550, and a reverse mechanism portion 560. The printing apparatus 500 gives (applies) a pretreatment liquid to the sheet material P loaded (supplied) from the loading portion 510 as necessary with the pretreatment portion 520 that is a pretreatment device, performs necessary printing by applying a liquid with the printing portion 530, dries the liquid adhering to the sheet material P with the drying portion 540, and then discharges the sheet material P to the unloading portion 550.

The loading portion 510 includes loading trays 511 (a lower loading tray 511A and an upper loading tray 511B) to accommodate multiple sheet materials P and feeding devices 512 (512A and 512B) to separate and feed the multiple sheet materials P one by one from the loading trays 511, and supplies the sheet materials P to the pretreatment portion 520.

The pretreatment portion 520 includes, e.g., an application portion 521 that is a treatment liquid application device that applies a treatment liquid having an action and an effect of aggregation of colorant of ink to prevent bleed-through to the printing face of the sheet material P.

The printing portion 530 includes a drum 531 that is a carrying member (rotating member) that carries the sheet material P on a circumferential face and rotates, and a liquid discharge portion 532 that discharges a liquid toward the sheet material P carried by the drum 531.

The printing portion 530 includes a transfer cylinder 534 that receives the sheet material P fed from the pretreatment portion 520 and transfers the sheet material P to the drum 531 and a transfer cylinder 535 that receives the sheet material P conveyed by the drum 531 and transfers the sheet material P to the drying portion 540.

The sheet material P conveyed from the pretreatment portion 520 to the printing portion 530 is conveyed in accordance with rotation of the transfer cylinder 534 while the leading end is gripped by a gripping device (sheet gripper) provided on the transfer cylinder 534. The sheet material P conveyed by the transfer cylinder 534 is transferred to the drum 531 at a position opposed to the drum 531.

The drum 531 has its face provided with a gripping device (sheet gripper), and the leading end of the sheet material P is gripped by the gripping device (sheet gripper). The drum 531 includes multiple suction holes dispersed on a face of the drum 531. A suction device generates suction airflows directed from desired suction holes of the drum 531 to an interior of the drum 531.

The sheet gripper of the drum 531 grips the leading end of the sheet material P forwarded from the transfer cylinder 534 to the drum 531, and the sheet material P is attracted to and carried on the drum 531 by the suction airflows generated by the suction device. As the drum 531 rotates, the sheet material P is conveyed.

The liquid discharge portion 532 includes discharge units 533 (533A to 533D) that are liquid discharge devices. For example, the discharge unit 533A discharges a liquid of cyan (C), the discharge unit 533B discharges a liquid of magenta (M), the discharge unit 533C discharges a liquid of yellow (Y), and the discharge unit 533D discharges a liquid of black (K). A discharge unit that discharges a special liquid, that is, white, gold (silver), or the like can also be used.

The discharge unit 533 includes multiple head units arranged in a staggered manner on a head attachment member 502. The liquid discharge head 1 of each head unit includes multiple nozzle rows (here, four rows are taken as an example, but it is not limited thereto) in which the multiple nozzles 11 that discharges the liquid is arranged. The arrow direction in FIG. 17 is the conveying direction of the sheet material P.

A discharge operation of each of the discharge units 533 of the liquid discharge portion 532 is controlled by a drive signal corresponding to print data. When the sheet material P carried on the drum 531 passes through a region facing the liquid discharge portion 532, the liquids of the respective colors are discharged from the discharge units 533, and an image corresponding to the print data is printed.

The drying portion 540 dries the liquids adhered to the sheet material P by the printing portion 530. Thus, the liquid component such as water in the liquids evaporates, the colorants contained in the liquids are fixed on the sheet material P, and curling of the sheet material P is reduced.

The reverse mechanism portion 560 is a mechanism that reverses, in switchback manner, the sheet material P that has passed through the drying portion 540 in double-sided printing. The reversed sheet material P is fed back to the upstream side of the transfer cylinder 534 through a conveyance passage 561 of the printing portion 530.

The unloading portion 550 includes an unloading tray 551 on which the multiple sheet materials P are stacked. The sheet materials P conveyed from the reverse mechanism portion 560 are sequentially stacked and held on the unloading tray 551.

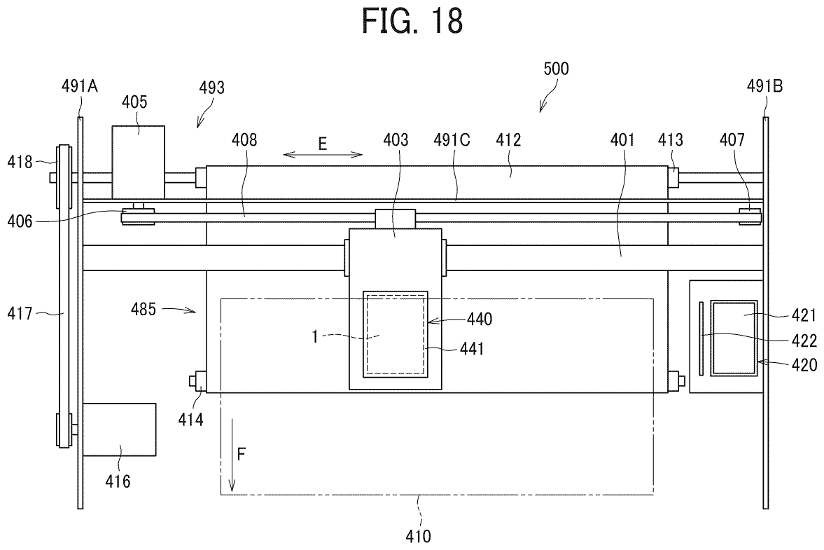

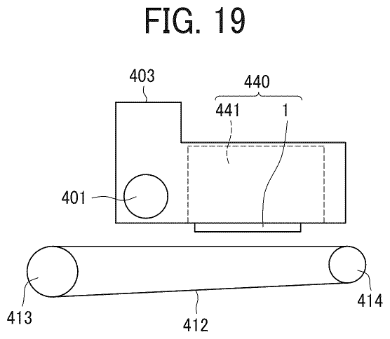

Next, another example of the printing apparatus serving as the liquid discharge apparatus according to the present embodiment is described with reference to FIGS. 18 and 19. FIG. 18 is a plan explanatory view of a main part of the printing apparatus of the present example. FIG. 19 is a side explanatory view of a main part of the printing apparatus of the present example.

The printing apparatus 500 of the present example is a serial type apparatus, and a carriage 403 is reciprocally moved in a main scanning direction E by a main scanning movement mechanism 493. The main scanning movement mechanism 493 includes a guide member 401, a main scanning motor 405, a timing belt 408, and the like. The guide member 401 is bridged between a left-side plate 491A and a right-side plate 491B to moveably hold the carriage 403. The main scanning motor 405 reciprocally moves the carriage 403 in the main scanning direction E via the timing belt 408 bridged between a drive pulley 406 and a driven pulley 407.

A liquid discharge unit 440 in which the liquid discharge head 1 and a head tank 441 according to the present embodiment are formed into a single unit is mounted on the carriage 403. The liquid discharge head 1 of the liquid discharge unit 440 discharges liquids of respective colors such as yellow (Y), cyan (C), magenta (M), and black (K). The liquid discharge head 1 is attached such that a nozzle row of multiple nozzles is disposed in a sub-scanning direction F orthogonal to the main scanning direction E with a downward discharge direction. The liquid discharge head 1 is coupled to a liquid circulation apparatus, and liquids of desired colors are circulated and supplied.

The printing apparatus 500 includes a conveyance mechanism 495 for conveying a sheet 410. The conveyance mechanism 495 includes a conveyance belt 412 as a conveyance device and a sub-scanning motor 416 to drive the conveyance belt 412. The conveyance belt 412 attracts the sheet 410 and conveys the sheet 410 at a position facing the liquid discharge head 1. The conveyance belt 412 is an endless belt stretched between a conveyance roller 413 and a tension roller 414. Attraction can be performed by electrostatic attraction, air suction, or the like. The conveyance belt 412 circumferentially moves in the sub-scanning direction F as the conveyance roller 413 is rotationally driven by the sub-scanning motor 416 via a timing belt 417 and a timing pulley 418.

On one side in the main scanning direction E of the carriage 403, a maintenance recovery mechanism 420 to maintain and recover the liquid discharge head 1 is arranged on a lateral side of the conveyance belt 412. The maintenance recovery mechanism 420 includes, for example, a cap member 421 to cap the nozzle face of the liquid discharge head 1 and a wiper member 422 to wipe the nozzle face. The main scanning movement mechanism 493, the maintenance recovery mechanism 420, and the conveyance mechanism 495 are mounted onto a housing including the left-side plate 491A, the right-side plate 491B and a back plate 491C.

In the printing apparatus 500 having the above-described configuration, the sheet 410 is fed and attracted onto the conveyance belt 412 and conveyed in the sub-scanning direction F by the circumferential movement of the conveyance belt 412. The liquid discharge head 1 is driven in response to an image signal while the carriage 403 is moved in the main scanning direction E to discharge the liquids onto the sheet 410 not in motion to form an image.

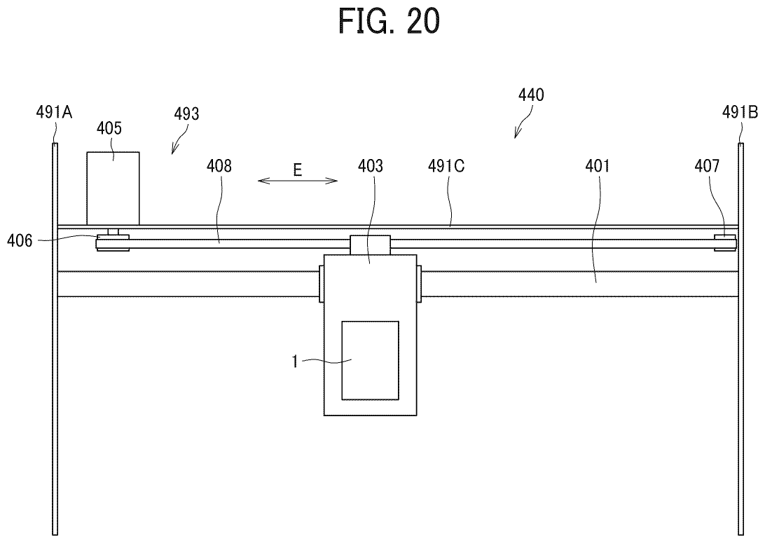

Next, another example of the liquid discharge unit according to the present embodiment is described with reference to FIG. 20. FIG. 20 is a plan explanatory view of a main part of the liquid discharge unit of the present example.

The liquid discharge unit 440 includes a housing part including the left-side plate 491A, the right-side plate 491B, and the back plate 491C, the main scanning movement mechanism 493, the carriage 403, and the liquid discharge head 1 among members constituting the liquid discharge apparatus.

In the liquid discharge unit 440, the maintenance recovery mechanism 420 described above may be mounted on, for example, the right-side plate 491B.

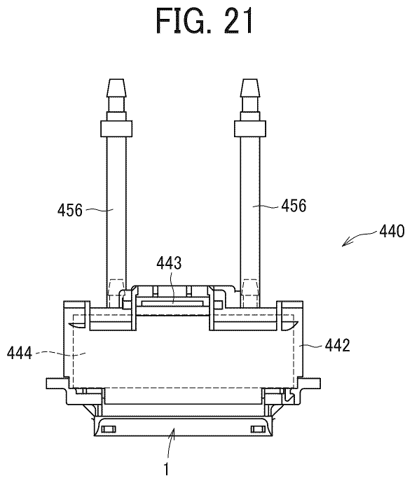

Next, yet another example of the liquid discharge unit according to the present embodiment is described with reference to FIG. 21. FIG. 21 is a front explanatory view of the liquid discharge unit of the present example.

The liquid discharge unit 440 includes the liquid discharge head 1 to which a channel part 444 is attached, and a tube 456 coupled to the channel part 444.

The channel part 444 is disposed inside a cover 442. Instead of the channel part 444, the liquid discharge unit 440 may include the head tank 441. A connector 443 electrically coupled with the liquid discharge head 1 is provided on an upper part of the channel part 444.

Although the present embodiment has been described above, the present embodiment is not limited to the above-described embodiment, and various modifications can be made without departing from the gist of the present embodiment.

In the present application, discharged liquid is not limited to a particular liquid as long as the liquid has a viscosity or face tension to be discharged from a head. However, preferably, the viscosity of the liquid is not greater than 30 mPa·s under ordinary temperature and ordinary pressure or by heating or cooling. Specific examples of such liquids include, but are not limited to, solutions, suspensions, and emulsions containing solvents (e.g., water, organic solvents), colorants (e.g., dyes, pigments), functionality imparting materials (e.g., polymerizable compounds, resins, surfactants), biocompatible materials (e.g., DNA (deoxyribonucleic acid), amino acid, protein, calcium), and/or edible materials (e.g., natural colorants). Such liquids can be used as inkjet inks, face treatment liquids, liquids for forming compositional elements of electric or luminous elements or electronic circuit resist patterns, and three-dimensional object forming material liquids.

The term “liquid” includes not only ink but also paint, a pretreatment liquid, a binder, and an overcoat liquid.

Examples of an energy source for generating energy to discharge liquid include a piezoelectric actuator (a laminated piezoelectric element or a thin-film piezoelectric element), a thermal actuator that employs a thermoelectric transducer element, such as a thermal resistor, and an electrostatic actuator including a diaphragm and opposed electrodes.

The “liquid discharge unit” is an assembly of parts relating to liquid discharge. The term “liquid discharge unit” represents a structure including the liquid discharge head and a functional part(s) or mechanism(s) combined with the liquid discharge head as a single unit. For example, the “liquid discharge unit” includes a combination of the liquid discharge head with at least one of a head tank, a carriage, a supply mechanism, a maintenance recovery mechanism, a main scanning movement mechanism, or a liquid circulation apparatus.

Examples of the single unit include a combination in which the liquid discharge head and functional parts and mechanisms are secured to each other through, e.g., fastening, bonding, or engaging, and a combination in which one of the liquid discharge head and the functional parts and mechanisms is movably held with respect to the other. The liquid discharge head and the functional part(s) or mechanism(s) may be detachably attached to each other.

For example, the liquid discharge head and the head tank may form the liquid discharge unit as a single unit. The liquid discharge head and the head tank may be formed into a single unit by being coupled with each other via a tube or the like. A unit including a filter may be added at a position between the head tank and the liquid discharge head of the liquid discharge unit.

The liquid discharge head and the carriage may be formed into a single unit as the liquid discharge unit.

The liquid discharge head is movably held on the guide member that constitutes a part of the scanning movement mechanism. Thus, the liquid discharge head and the scanning movement mechanism may be formed into a single unit to be the liquid discharge unit. The liquid discharge head, the carriage, and the main scanning movement mechanism may form a single unit.

A cap member that forms a part of the maintenance recovery mechanism may be secured to the carriage mounting the liquid discharge head so that the liquid discharge head, the carriage, and the maintenance recovery mechanism are formed into a single unit as the liquid discharge unit.

The liquid discharge unit may include a tube coupled to the head tank or the liquid discharge head mounting a channel part so that the liquid discharge head and the supply mechanism form a single unit. A liquid in a liquid reservoir source is supplied to the liquid discharge head through this tube.

The main scanning movement mechanism may be a guide member. The supply mechanism includes a tube(s) or a loading portion.

Here, the “liquid discharge unit” is described in a combined manner with the liquid discharge head, and the “liquid discharge unit” also includes those in which a head module or a head unit including the liquid discharge head described above with the functional parts or mechanisms described above are formed into a single unit.

The term “liquid discharge apparatus” includes an apparatus that includes the liquid discharge head, the liquid discharge unit, the head module, the head unit, and the like, and discharges liquid by driving the liquid discharge head. The liquid discharge apparatus used here includes, in addition to apparatuses to discharge liquid to an object on which liquid can be attached, apparatuses to discharge the liquid into gas (air) or liquid.

The “liquid discharge apparatus” may include a device regarding feeding, conveyance, and paper ejection of an object on which liquid can be attached, a pretreatment apparatus, and a posttreatment apparatus.

The “liquid discharge apparatus” may be, for example, an image forming apparatus to form an image on a sheet by discharging ink, or a three-dimensional fabrication apparatus to discharge a fabrication liquid to a powder layer in which powder material is formed in layers to form a three-dimensional fabrication object.

The term “liquid discharge apparatus” is not limited to an apparatus to discharge liquid to visualize meaningful images, such as letters or figures. For example, the liquid discharge apparatus may be an apparatus that forms patterns having no meaning or an apparatus that fabricates three-dimensional images.

The above-described term “object on which liquid can be attached” represents an object on which liquid can be at least temporarily attached, an object on which liquid is attached and fixed, or an object into which liquid is attached and permeates. The object on which liquid can be attached is a recording medium in the above embodiment. Examples include recording media, such as paper sheet, recording paper, recording sheet of paper, film, and cloth, electronic component, such as electronic substrate and piezoelectric element, and media, such as powder layer, organ model, and testing cell. The “object on which liquid can be attached” includes any object on which liquid can be attached, unless particularly limited.

Examples of the material of the “object on which liquid can be attached” may be any materials on which liquid can be attached even temporarily, such as paper, thread, fiber, fabric, leather, metal, plastic, glass, wood, and ceramic.

Examples of the “liquid discharge apparatus” further include a treatment liquid applying apparatus that discharges a treatment liquid onto a sheet to apply the treatment liquid to the face of the sheet for the purpose of modifying the face of the sheet, and an ejection granulating apparatus that ejects a composition liquid in which a raw material is dispersed in a solution through a nozzle to granulate fine particles of the raw material.

A liquid discharge head includes: a nozzle plate (10) having a nozzle (11) to discharge a liquid in a discharge direction, a damper (23); a damper support (22) having: a first face facing in the discharge direction, the first face supporting the damper (23); a second face facing in an opposite direction opposite to the discharge direction; a through hole (22a) opened to the opposite direction; and a joining portion (recessed portion 22b) on the second face and facing in the opposite direction; and a joint (cover pedestal 24) joined to the joining portion of the damper support with an adhesive. The damper support (21, 22) includes a step (26) rising to the opposite direction from the joining portion, and the step is disposed between the joining portion and the through hole in a transverse direction orthogonal to the discharge direction.

The damper support has a third face rising from the second face in the opposite direction to form the step, and the through hole is disposed on the third face of the damper support. The damper support has multiple through holes including the through hole on the third face, and the damper support has the step in a longitudinal direction orthogonal to the discharge direction and the transverse direction. The step is in a region where the multiple through holes are formed.

The damper support has a protrusion protruding from the third face, the protrusion has the through hole in the protrusion. The joint has a recessed portion on a longitudinal end of the joint in a longitudinal direction orthogonal to the discharge direction and the transverse direction, the recessed portion is recessed in the opposite direction away from the damper support, and at least a part of the recessed portion overlaps with the step in the longitudinal direction.

The joint has an abutment portion protruding to the damper support and contacts the damper support, and the abutment portion forms a gap to be filled with the adhesive between the joining portion and the joint when the damper support and the joint are joined. The damper support has an abutment portion protruding to the joint and contacts the joint, and the abutment portion forms a gap to be filled with the adhesive between the joining portion and the joint when the damper support and the joint are joined. The abutment portion is disposed outside a region where the through hole is provided in a longitudinal direction orthogonal to the discharge direction and the transverse direction. A head unit includes: the liquid discharge head; and a cover (25) joint to the joint (cover pedestal 24) of the liquid discharge head. A liquid discharge apparatus includes the liquid discharge head.

A liquid discharge head includes: a nozzle plate (10) having a nozzle (11) to discharge a liquid in a discharge direction, a damper (23); a damper support (22) having: a first face facing in the discharge direction, the first face supporting the damper (23); a second face facing in an opposite direction opposite to the discharge direction; a through hole (22a) opened to the opposite direction; and a joining portion (recessed portion 22b) on the second face and facing in the opposite direction; and a joint (cover pedestal 24) joined to the joining portion of the damper support with an adhesive. The damper support (21, 22) includes a protrusion (22f) protruding to the opposite direction from the joining portion, and the protrusion (22f) is disposed between the joining portion and the through hole in a transverse direction orthogonal to the discharge direction.

The terms of image formation, recording, printing, image printing, and fabricating used in the present application may be used synonymously with each other.

According to the present embodiment, it is possible to suppress the entry of the adhesive into the through hole.

Aspects of the present embodiment are, for example, as follows.

### Aspect 1

According to Aspect 1, a liquid discharge head includes:
a nozzle that discharges liquid;
a damper;
a damper holder that has a through hole and a joining portion, and holds the damper from a side opposite to a nozzle side; and
a joint that is joined to the joining portion with an adhesive on a side of the damper holder opposite to a damper side,
wherein the through hole opens to a joint side of the damper holder, and
the damper holder includes, between the joining portion and the through hole, a step protruding to the joint side with respect to the joining portion.

### Aspect 2

According to Aspect 2, in the liquid discharge head of Aspect 1,
the damper holder includes a first face portion in which an end of the through hole on the joint side is provided, and
the first face portion protrudes to the joint side with respect to the joining portion to form a step shape with respect to the joining portion so as to form the step.

### Aspect 3

According to Aspect 3, in the liquid discharge head of Aspect 2,
the damper holder has multiple through holes, and
the first face portion protrudes to the joint side with respect to the joining portion in an entire region where the through holes in a longitudinal direction of the damper holder are provided.

### Aspect 4

According to Aspect 4, in the liquid discharge head of any of Aspects 1 to 3, the step is a wall portion having a through hole on an inner side of the step.

### Aspect 5

According to Aspect 5, in the liquid discharge head of any of Aspects 1 to 4,
the joint includes a joint-side recessed portion recessed in a direction away from the damper holder on a longitudinal end side of the joint, and
at least a part of the joint-side recessed portion overlaps a position in the longitudinal direction where the step is provided.

### Aspect 6

According to Aspect 6, in the liquid discharge head of any of Aspects 1 to 5, at least one of the damper holder and the joint includes an abutment portion that protrudes to another side of the damper holder or the joint and contacts another of the damper holder and the joint, and forms a gap to be filled with the adhesive between the joining portion and the joint when the damper holder and the joint are joined.

### Aspect 7

According to Aspect 7, in the liquid discharge head of Aspect 5, the abutment portion is provided outside a region where the through hole is provided in the longitudinal direction of the damper holder.

### Aspect 8

According to Aspect 8, a head unit includes:
the liquid discharge head of any of Aspects 1 to 7; and
a cover that covers a side opposite to the nozzle side of the liquid discharge head.

### Aspect 9

According to Aspect 9, a liquid discharge apparatus includes the liquid discharge head of any of Aspects 1 to 7.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
a nozzle plate having a nozzle to discharge a liquid in a discharge direction;
a damper;
a damper support having:
a first face facing in the discharge direction, the first face supporting the damper;
a second face facing in an opposite direction opposite to the discharge direction;
a through hole opened to the opposite direction; and
a joining portion on the second face and facing in the opposite direction; and
a joint joined to the joining portion of the damper support with an adhesive,
wherein the damper support includes a step rising to the opposite direction from the joining portion, and
the step is disposed between the joining portion and the through hole in a transverse direction orthogonal to the discharge direction.

2. The liquid discharge head according to claim 1,
wherein the damper support has a third face rising from the second face in the opposite direction to form the step, and
the through hole is disposed on the third face of the damper support.

3. The liquid discharge head according to claim 2,
wherein the damper support has multiple through holes including the through hole on the third face,
the damper support has the step extending in a longitudinal direction orthogonal to the discharge direction and the transverse direction, and
the step is in a region where the multiple through holes are formed.

4. The liquid discharge head according to claim 2,
wherein damper support has a protrusion protruding from the third face,
the protrusion has the through hole in the protrusion.

5. The liquid discharge head according to claim 2,
wherein the joint has a recessed portion on a longitudinal end of the joint in a longitudinal direction orthogonal to the discharge direction and the transverse direction, and
the recessed portion is recessed in the opposite direction away from the damper support,
at least a part of the recessed portion overlaps with the step in the longitudinal direction.

6. The liquid discharge head according to claim 1,
wherein the joint has an abutment portion protruding to the damper support and contacts the damper support, and
the abutment portion forms a gap to be filled with the adhesive between the joining portion and the joint when the damper support and the joint are joined.

7. The liquid discharge head according to claim 1,
wherein the damper support has an abutment portion protruding to the joint and contacts the joint, and
the abutment portion forms a gap to be filled with the adhesive between the joining portion and the joint when the damper support and the joint are joined.

8. The liquid discharge head according to claim 6,
wherein the abutment portion is disposed outside a region where the through hole is provided in a longitudinal direction orthogonal to the discharge direction and the transverse direction.

9. A head unit comprising:
the liquid discharge head according to claim 1; and
a cover joint to the joint of the liquid discharge head.

10. A liquid discharge apparatus comprising the liquid discharge head according to claim 1.

11. A liquid discharge head comprising:
a nozzle plate having a nozzle to discharge a liquid in a discharge direction;
a damper;
a damper support having:
a first face facing in the discharge direction, the first face supporting the damper;
a second face facing in an opposite direction opposite to the discharge direction;
a through hole opened to the opposite direction; and
a joining portion on the second face and facing in the opposite direction; and
a joint joined to the joining portion of the damper support with an adhesive,
wherein the damper support includes a protrusion protruding to the opposite direction from the joining portion, and
the protrusion is disposed between the joining portion and the through hole in a transverse direction orthogonal to the discharge direction.
